(19) United States
(12) Patent Application Publication
(10) Pub. No.: US 2016/0230049 A1
(43) Pub. Date: Aug. 11, 2016

(54) REVERSIBLE PRESSURE-SENSITIVE ADHESIVE MASS

(71) Applicant: TESA SE, Norderstedt (DE)

(72) Inventors: Marc HUSEMANN, Hamburg (DE); Kai ELLRINGMANN, Hamburg (DE)

(73) Assignee: tesa SE, Hamburg (DE)

(21) Appl. No.: 15/023,772

(22) PCT Filed: Sep. 15, 2014
(86) PCT No.: PCT/EP2014/069618

§ 371 Date: Mar. 22, 2016

(30) Foreign Application Priority Data
Sep. 27, 2013 (DE) 10 2013 219 491.9

(51) Int. Cl. C09J 7/02; C09J 133/08; C08F 220/68

(52) U.S. Cl. CPC C09J 7/0217; C08F 220/68; C09J 133/08; C09J 2433/00; C09J 2203/326

(57) ABSTRACT

Pressure-sensitive adhesive mass comprising an at least partially cross-linked polyacrylate, based on a monomer mixture comprising a) 5 to 100 wt % acrylic acid esters of the formula CR32=C(R2)(COOR1) as monomers A, b) 0 to 95 wt % of acrylic acid esters of the formula CR62=C(R5)(COOR4) as monomers B, c) 0 to 5 wt % of monomers having at least one alcoholic hydroxyl group as monomers C; d) 0 to 5 wt % of monomers having at least one COOH— group as monomers D; e) 0-5 wt % of monomers having at least one epoxy group as monomers E, and f) 0 to 2.5 wt % of monomers having at least one UV-activatable group as monomers F.

This is a 371 of PCT/EP2014/069618 filed 15 Sep. 2014, which claims foreign priority benefit under 35 U.S.C. 119 of German Patent Application 10 2013 219 491.9 filed Sep. 27, 2013, the entire contents of which are incorporated herein by reference.

The invention relates to a pressure-sensitive adhesive, to an adhesive tape comprising such an adhesive, and to the methods for producing them, to the use of the pressure-sensitive adhesive, and to the use of monomers.

### BACKGROUND OF THE INVENTION

Reversible pressure-sensitive adhesive tapes are employed very multifariously across a range of many different applications. For these applications these pressure-sensitive adhesive tapes ought, after bonding, to be residuelessly removable from the substrates again. This is occasionally difficult to accomplish, particularly if the bond has stood for a long time. Given a multiplicity of possible commercial applications, different paths have been taken to date to produce reversible pressure-sensitive adhesives and consequently reversible pressure-sensitive adhesive tapes produced from them as well:

One commercial double-sided application from the consumer sector are, for example, the tesa Powerstrips™, which are removable again by stretching even after prolonged bonding. This class of adhesives, however, cannot be used very efficiently for industrial applications, where requirements include high aging stability and high temperature stability.

Another theoretical procedure is the structuring of the pressure-sensitive adhesives, the reversibility here being produced through a reduction in the bonding area. A disadvantage of this procedure is that the structuring renders the adhesives unsuitable for optical applications. Structuring is oftentimes also costly and inconvenient.

One possibility of structuring is described in WO 85/04602. It takes a pressure-sensitive adhesive tape with a given bond strength, reduces the bonding area by means of a specific pattern or specific structure, and so lowers the bond strength of the pressure-sensitive adhesive tape.

The procedure described in U.S. Pat. No. 4,587,152 was similar. There, a pressure-sensitive adhesive sheet was produced in a screen printing process. The pressure-sensitive adhesive properties can then be controlled in accordance with the structure generated.

U.S. Pat. No. 5,194,299 applies pressure-sensitive adhesive islands, for which preferably a spray process is employed. In this process, 10% to 85% of the area is covered over by a pressure-sensitive adhesive. Here, furthermore, the technical adhesive properties can be controlled through the population density of these islands.

U.S. Pat. No. 4,889,234 describes pressure-sensitive adhesive labels. Here again, a structure is generated in the adhesive in order to reduce the bonding area.

In addition to structuring through coating or patterning, controlled crosslinking may likewise be used to obtain a structure and so to achieve reversibility for a pressure-sensitive adhesive. U.S. Pat. No. 4,599,265 describes pressure-sensitive acrylate adhesives which are subjected to segmented crosslinking, a very complicated procedure technically.

As well as structuring, a further approach to the production of reversible pressure-sensitive adhesives involves chemical modification to the pressure-sensitive adhesives, causing their bond strength to fall. One chemical solution lies in pressure-sensitive adhesive tapes with grafted polysiloxane units, as are described in U.S. Pat. No. 4,693,935. In this case, however, the technical adhesive properties are difficult to control.

In general, conventional pressure-sensitive adhesives occasionally have inadequate temperature stability and aging stability, or cannot be adequately removed again if the bond has stood for a long time. This is the case especially for adhesive bonds with high bond strengths.

It is an object of the invention, therefore, to provide a pressure-sensitive adhesive (PSA) having improved properties. Further objects are to specify a production method for a PSA of this kind, an adhesive tape comprising the PSA, a production method for the adhesive tape, and a use for the PSA, and the use of monomers.

A pressure-sensitive adhesive (PSA) is specified. According to at least one embodiment, the PSA comprises an at least partly crosslinked polyacrylate based on a monomer mixture, said monomer mixture comprising
a) 5 to 100 wt % of acrylic esters of the formula CR³₂═C(R²)(COOR¹) as monomers A, where R¹ is a branched alkyl group having 16 to 22 C atoms, and has at least two branching locations, R² is selected from H, methyl or halogen, and R³ independently at each occurrence is selected from H or halogen,
b) 0 to 95 wt % of acrylic esters of the formula CR⁶₂═C(R⁵)(COOR⁴) as monomers B, where R⁴ is a linear, singly branched, cyclic or polycyclic alkyl group having 1 to 14 C atoms, R⁵ is selected from H, methyl or halogen, and R⁶ independently at each occurrence is selected from H or halogen,
c) 0 to 5 wt % of monomers having at least one alcoholic hydroxyl group as monomers C,
d) 0 to 5 wt % of monomers having at least one COOH group as monomers D,
e) 0 to 5 wt % of monomers having at least one epoxy group as monomers E, and
f) 0 to 2.5 wt % of monomers having at least one UV-activatable group as monomers F.

The monomers A, B, C, D, E, and F may each independently of one another be a mixture of compounds or else a pure compound. “wt %” stands for percent by weight. Halogens may be selected from F, Cl, Br, I, and combinations thereof, more particularly from F and CI and combinations thereof. The PSA may also consist of the polyacrylate. The at least partly crosslinked polyacrylate comprises polymer strands which come about through polymerization of the monomer mixture and have subsequently undergone at least partial crosslinking with one another.

The PSA of the invention displays reversible pressure-sensitive adhesion properties and is therefore especially suitable for reversible adhesive bonding. Accordingly it may also be referred to as “reversible pressure-sensitive adhesive” or “reversible PSA”.

### DETAILED DESCRIPTION

The qualities of the PSA of the invention include high temperature stability and aging stability, which are also accompanied by good cohesion properties. The adhesive can therefore be removed again from a substrate, also largely and, in particular, entirely without residue, even if the bond has already stood for a relatively long time.

Furthermore, the adhesive has good flow-on properties, and in particular a uniform flow-on is made possible. Through the PSA of the invention, therefore, substantial drawbacks of conventional reversible PSAs are overcome.

The inventors found, surprisingly, that through the use of the monomers A in particular, the advantageous properties of the PSA are made possible, especially since as a result of this monomer they are only able to develop a low degree of polar interactions with a substrate to be bonded.

The monomers A are notable in particular for the long, highly branched alkyl groups R¹. On account of the high degree of branching, the monomers show no tendency toward crystallization, and especially not toward side chain crystallization. Hence a homopolymer of the monomers A has a statistical glass transition temperature T_{g} of less than 0° C., more particularly less than −20° C. According to certain embodiments, the statistical glass transition temperature of such a homopolymer may even be lower than −40° C., and occasionally, indeed, less than −60° C. The T_{g} is determined according to DIN 53765:1994-03. Through the proportion of the monomers A, then, the glass transition temperature of the polyacrylate can be lowered or a low glass transition temperature can be obtained for the PSA. There is a substantial difference in this relative to conventional alkyl acrylic acid esters having long, singly branched or entirely unbranched alkyl groups, such as stearyl acrylate, for example, which tend toward crystallization and so lead to an increase in the glass transition temperature. The glass transition temperature of the PSA of the invention is generally <25° C., more particularly <15° C.

The low glass transition temperature is accompanied by good flow-on properties. The PSA is therefore able in particular to flow on uniformly. The tan δ (determined by Test method B) for the PSAs of the invention is generally between 0.05 and 0.8, more particularly between 0.15 and 0.7, and preferably between 0.3 and 0.6, which is in harmony with good flow-on properties.

It has further emerged, surprisingly, that the monomers A lead to very good crosslinking efficiency, especially on radical crosslinking. The inventors assume that tertiary radicals, in other words highly stable radicals, are able easily to form at the branching locations. These radicals can be crosslinked with one another, allowing crosslinking to take place via the side chains of the monomers A as well, particularly if a high fraction of monomers A is chosen. One of the results of this is very good cohesion properties on the part of the PSA. On account of the effective crosslinking, the PSA generally has high temperature stability and aging stability. A PSA of the invention can easily be heated, for example, at 200° C. for 15 minutes. Because of the special crosslinking, it can generally also be diecut effectively. The PSA is therefore highly suitable for industrial applications as well. Furthermore, on account of the advantageous crosslinking described above, the PSAs of the invention also exhibit high stability with respect to plasticizers.

Their highly branched, long alkyl chain R¹ makes the monomers A very apolar. They also help to give the polyacrylate a decidedly apolar character, since, for example, the comparatively polar acrylate scaffold of the polyacrylate is shielded toward the outside. The shielding is very efficient as a result of the branching locations and/or the side chains attached to them. It is possible as a result largely to prevent dipole-dipole interactions with a substrate to be bonded, and so the bond strength of the PSA as well is able to stay the same over relatively long periods of time. The PSA of the invention can advantageously be detached again without residue even from polar substrates, such as steel, polyethylene terephthalate (PET) or polycarbonate (PC), for example, which may permit a very high bonding strength. They are also suitable, therefore, very effectively for reversible bonding on polar substrates.

On account of the particular properties of the PSA, especially the good cohesion properties and the high stability and the apolar character, the properties of the PSA that are defined at the production stage are generally retained for a long period. The PSA can therefore be detached from a substrate again in general even after long bonding. This is of great importance for applications in the electronics sector, for example.

Within the electronics industry, pressure-sensitive adhesive tapes are used, for example, to attach individual components or as surface protection. Not least in view of new statutory regulations, however, a major part of the electronic components ought also to be recyclable. In this branch of industry, therefore, there is a high demand for use of reversible PSAs. For this purpose it is possible with advantage to use the PSAs of the invention, and pressure-sensitive adhesive tapes produced from them, since these adhesives and tapes can be detached again without residue even after a long period, as for example on the repair or recycling of a component.

The polyacrylate may be constructed entirely of monomers A or else may be based proportionally on other monomers, especially the monomers B, C, D, E or F, possibly also in combinations. By way of the choice of the monomers, and possibly also of additives, the properties of the PSA, such as the bond strength or the polarity, for example, can be modified or fine-tuned. The possibility therefore exists of adjusting the properties of the PSA of the invention in a simple way for certain applications without the need for costly and inconvenient structuring techniques or structured crosslinking to achieve this. Herein lies a further advantage over conventional PSAs.

The polyacrylate may have an average molecular weight of 50 000 to 4 000 000 g/mol, more particularly 100 000 to 3 000 000 g/mol, and preferably 400 000 to 1 400 000 g/mol. The average molecular weight is determined via gel permeation chromatography (GPC) (Test method A).

As already described above, the high degree of branching of the alkyl groups R¹ in the monomers A is important for the properties of the PSA. The alkyl groups R¹ have a main chain, on which side chains are attached at the branching locations. The branching locations therefore correspond to tertiary and quaternary, but especially tertiary carbon atoms in the alkyl group R¹. The branching locations, like the amount of monomers A in the PSA as well, can be verified or determined by means for example of ¹³C NMR spectroscopy.

According to a further embodiment, at least half of the monomers A have an alkyl group R¹ with three or more branching locations. At least 75%, more particularly at least 90%, or else all of the monomers A may have an alkyl group R¹ with three or more branching locations. In general the monomers A have 3 or 4, more particularly 3, branching locations. A higher amount of branching locations leads in general to a lower crystallization tendency, a lower glass transition temperature, and a further-improved crosslinking via the side chains, hence also enabling the corresponding advantages in improved form.

According to one further embodiment, R² is selected from H or methyl and R³ is H in the monomers A. In that case the monomers A are alkyl esters of acrylic acid and/or methacrylic acid. These are generally more favorable in production than the halogenated derivatives.

The alkyl groups R¹ of the monomers A are preferably pure hydrocarbon radicals.

As already described above, the alkyl groups R¹ of the monomers A have a main chain on which side chains are attached at the branching locations. According to a further embodiment, at least 75%, more particularly at least 90%, or all of these side chains have 2 to 4 C atoms. Side chains of this size are advantageous since they lead to less stiff alkyl radicals R¹ than do methyl groups, for example. In particular they ensure a very low crystallization tendency and effective shielding of the polar scaffold in the polyacrylate.

According to another embodiment, the branching locations in the alkyl groups R¹ of the monomers A are spaced apart by hydrocarbon chains having 2 to 5, more particularly 3 to 4, C atoms. The alkyl groups R¹ of the monomers A preferably have a construction reminiscent of dendrimers.

In a further advantageous refinement, the alkyl groups R¹ of the monomers A are selected from triply branched C17 alkyl groups.

The monomers A may be formed, for example, by esterification of acrylic acid or an acrylic acid derivative with a corresponding branched alkyl alcohol, i.e., R¹—OH. The parent alcohol R¹—OH may be obtained, for example, during the steam cracking of oil, or else prepared entirely synthetically. Purification is possible by distillation or using chromatographic methods. The parent alcohols are described in WO 2009/124979, the relevant disclosure content of which is hereby incorporated by reference. The esterification of the alcohols to the acrylate is described in WO 2011/64190, the relevant disclosure content of which is hereby incorporated by reference.

The monomers B may be used as a supplement to the monomer A for preparing the polyacrylate or producing the PSA. The alkyl group R⁴ is selected such that the monomers B are still relatively apolar and do not display high crystallization tendency. The monomers B can also be mixed effectively with the monomers A. The choice of the monomers B allows the properties of the PSA to be fine-tuned. They may be less expensive than the monomers A, such that combinations of the monomers A and B are also attractive economically.

In a further embodiment, the monomer mixture has a fraction of at least 5 wt % of monomers B.

In a further embodiment, R⁵ is selected from H and methyl and R⁶ is H in the monomers B.

According to a further embodiment, R⁴ in the monomers B is selected from a group which encompasses methyl, ethyl, propyl, pentyl, hexyl, heptyl, octyl, nonyl, decyl, undecyl, lauryl, and the branched isomers thereof, cycloalkyl groups and polycyclic alkyl groups, it being possible for the cycloalkyl groups and polycyclic alkyl groups to be substituted by alkyl groups, halogen atoms or cyano groups, and combinations thereof. Examples of branched isomers are isobutyl, 2-ethylhexyl, and isooctyl. Examples of cyclic and polycyclic alkyl groups R⁴ are cyclohexyl, isobornyl, and 3,5-dimethyladamantyl.

According to a further embodiment, the monomers B are selected from a group which encompasses methyl acrylate, methyl methacrylate, ethyl acrylate, n-butyl methacrylate, n-octyl methacrylate, 2-ethylhexyl methacrylate, isooctyl methacrylate, cyclohexyl methacrylate, isobornyl acrylate, isobornyl methacrylate, 3,5-dimethyladamantyl acryl, isobutyl acrylate, 2-ethylhexyl acrylate, isooctyl acrylate, and a combination thereof.

According to a further embodiment, the alkyl group R⁴ of the monomers B contains 4 to 10 C atoms. A corresponding selection of embodiments and examples stated above can be made.

As already described above, the polyacrylate comprises a fraction of monomers A of 5 to 100 wt % of the parent monomer mixture. In order to obtain a decidedly apolar character and effective crosslinking, a high proportion of monomers A is appropriate in the monomer mixture on which the polyacrylate is based. According to a further embodiment, the monomer mixture comprises a fraction of at least 45 wt %, more particularly at least 60 wt %, and preferably at least 70 wt %. The fraction of monomers A may amount to at least 80 wt % or even at least 90 wt %.

According to a further embodiment, the monomer mixture comprises 5 to 45 wt %, more particularly 10 to 30 wt %, of monomers B. In such an embodiment a fraction of at least 45 wt % of monomers A is generally employed.

Advantageous polyacrylates having a pronounced apolar character may also be obtained by the presence in the monomer mixture of the monomers A and B in corresponding amounts. According to one further embodiment, the monomer mixture comprises at least 80 wt %, more particularly at least 90 wt %, of monomers A or at least 80 wt %, more particularly at least 90 wt %, of the monomers A and B together.

On economic grounds in particular, embodiments may also be appropriate that include a relatively low fraction of monomers A in the monomer mixture. According to one further embodiment, the monomer mixture comprises a fraction of monomers A of up to 40 wt %, more particularly up to 30 wt %. The mixture may comprise, for example, a fraction of monomers A of 5 to 25 wt %, more particularly 5 to 15 wt %. The monomer mixture in this case may comprise a fraction of monomers B of at least 40 wt %, more particularly at least 50 wt %, and preferably at least 60 wt %. It may also comprise a fraction of monomers B of at least 75 wt %.

The polyacrylate may be based on the monomer A alone or else on a combination of the monomers A and B. Depending on the method of crosslinking, it may be advantageous for the monomer mixture to comprise monomers of type C, D, E or F or a combination thereof as well. The monomers C, D, and E facilitate thermal crosslinking, for example. The monomers F are employed in particular in the case of crosslinking by means of irradiation with UV radiation. Via the monomers C, D, E, F or combinations thereof it is possible with little cost and complexity to carry out modification or fine-tuning of properties of the polyacrylate, examples being the polarity or the bond strength.

According to a further embodiment, the monomer mixture comprises at least one of the monomers C, D, E, and F at not less than 0.01 wt % in each case.

The monomers C, D, and E it is possible to make use, in each case independently of one another, in a fraction of 0.1 to 4 wt %, more particularly 0.5 to 3 wt %. The monomers F can be used in a fraction of 0.1 to 2, more particularly 0.5 to 1.5 wt %. A combination of the monomers F with the monomers C or D is advantageous, for example, since the polarity of the hydroxyl groups and/or of the carboxylic acid groups can be utilized for increasing the bond strength and in that case, independently of this, it is possible to carry out crosslinking of the polymer with UV light. This is appropriate, for example, in the context of processing in the form of hotmelt PSA.

Monomers C carry an alcoholic hydroxyl group and are copolymerizable with alkyl acrylates, such as the monomers A and B, for example. They preferably carry no COOH group and no epoxy group. Monomers C are not included among the monomers A, B, D, E, and F.

According to a further embodiment, the monomer mixture comprises monomers C. Monomers C may be selected in particular from hydroxyalkyl esters of acrylic acid and methacrylic acid, N-hydroxyalkylated acrylamides and methacrylamides, and combinations thereof. Hydroxyalkyl groups may also be hydroxy-terminated. The monomers C may be selected, for example, from a group which encompasses 2-hydroxyethyl acrylate, 2-hydroxypropyl acrylate, 2-hydroxybutyl acrylate, 2-hydoxyethyl methacrylate, 2-hydroxypropyl methacrylate, 2-hydroxybutyl methacrylate, 2-hydroxy-ethylacrylamide, N-hydroxypropylacrylamide, ethylene glycol acrylate, propylene glycol acrylate, and a combination thereof.

Monomers D have a COOH group, in other words a free carboxylic acid group, and are copolymerizable with alkyl acrylates, such as the monomers A and B, for example. They preferably carry no alcoholic hydroxyl group and no epoxy group. Monomers D are not included among monomers A, B, C, E, and F.

According to a further embodiment, the monomer mixture comprises monomers D. Monomers D may be selected, for example, from a group which encompasses acrylic acid, methacrylic acid, itaconic acid, 4-vinylbenzoic acid, fumaric acid, vinylacetic acid, β-acryloyloxypropionic acid, trichloroacrylic acid, crotonic acid, aconitic acid, dimethylacrylic acid, and a combination thereof.

Monomers E have an epoxy group and are copolymerizable with alkyl acrylates, such as the monomers A and B, for example. They preferably have no free hydroxyl and carboxylic acid groups. Monomers E are not included among the monomers A, B, C, D, and F.

According to a further embodiment, the monomer mixture comprises monomers E. Monomer E may be selected, for example, from a group which encompasses glycidyl acrylate, glycidyl methacrylate, and a combination thereof.

Monomers F comprise a UV-activatable group, which preferably can be activated with UV radiation of between 200 and 400 nm in wavelength and then forms radical fragments. Monomers F are able accordingly to contribute to the crosslinking of the polymer. They are copolymerizable in particular with alkyl acrylates, such as the monomers A and B, for example. Monomers F are not included among the monomers A, B, and E. They differ from the monomers C and D at least in the fact that the latter have no UV-activatable group.

According to a further embodiment, the monomer mixture comprises monomers F. Monomers F may be selected, for example, from a group which encompasses benzoin acrylate, acrylated benzophenone from UCB (Ebecryl P 36®), and a combination thereof. In principle it is possible for any photoinitiators known to the skilled person to be copolymerized that are able to crosslink the polymer via a radical mechanism under UV irradiation. An overview of possible photoinitiators which can be used and which can be functionalized with a double bond is given in Fouassier: “Photoinitiation, photopolymerization and photocuring: Fundamentals and applications”, Hanser-Verlag, Munich 1995, the relevant disclosure content of which is hereby incorporated by reference. As a supplement, reference is made to Carroy et al. in “Chemistry and technology of UV and EB formulation for coatings, inks and paints”, Oldring (Ed.), 1994, SITA, London, the relevant disclosure content of which is hereby incorporated by reference.

Typical copolymerizable photoinitiators, more particularly those of the Norrish I or Norrish II type, may comprise in particular at least one of the following radicals: benzophenone-, acetophenone-, benzil-, benzoin-, hydroxyalkylphenone-, phenyl cyclohexyl ketone-, anthraquinone-, trimethylbenzoylphosphine oxide-, methylthiophenylmorpholine ketone-, aminoketone-, azobenzoin-, thioxanthone-, hexarylbisimidazole-, triazine-, or fluorenone, it being possible for each of these radicals additionally to be substituted by one or more halogen atoms and/or by one or more alkyloxy groups and/or by one or more amino groups or hydroxyl groups. The nomination of these radicals is only by way of example, and is not restricting.

According to a further embodiment, the monomer mixture comprises a fraction of up to 20 wt %, more particularly up to 15 wt % and preferably up to 10 wt %, of alkyl acrylic acid esters or alkyl methacrylic acid esters having linear or singly branched alkyl groups with 16 to 22 C atoms. The monomer mixture, for example, may comprise 0.1 to 5 wt % of these monomers. In principle, admittedly, such monomers do raise the glass transition temperature, but this effect is not so greatly pronounced when their level in the polyacrylate is low. Monomers of this kind may be used, for example, to fine-tune the properties of the PSA. Examples of these monomers are stearyl acrylate and behenyl acrylate. By means of high proportions of the monomers A as well it is possible to ensure that the relatively long side chains of stearyl acrylate, for example, are accommodated in the apolar side chain matrix of the monomers A and so instances of side chain crystallization are prevented.

In principle, for the purpose of obtaining a preferred glass transition temperature T_{g} of T_{g}<25° C., in accordance with the remarks above, the monomers can be selected, and the quantitative composition of the monomer mixture selected, in such a way that the desired T_{g} comes about in accordance with the Fox equation (E1) (cf. T. G. Fox, Bull. Am. Phys. Soc. 1 (1956) 123).

$$\frac{1}{{T}_{g}} = {\sum }_{n} \frac{{w}_{n}}{{T}_{g , n}} \qquad ( E1 )$$

In this equation, n represents the serial number of the monomers used, Wₙ the mass fraction of the respective monomer n (wt %), and T_{g,n} the respective glass transition temperature of the homopolymer of each of the monomers n, in K.

As well as the selection of the monomers for the monomer mixture from which the polyacrylate is formed, the properties of the PSA can also be modified through additives. The PSA may therefore comprise or else consist of polyacrylate and additives. Examples of conceivable additives include plasticizers, tackifying resins, and further additives such as fillers or aging inhibitors. They can also be employed in combinations.

According to a further embodiment, the PSA comprises plasticizers, which are present in a fraction of up to 25 parts by weight, based on 100 parts by weight of polyacrylate, in the PSA. The fraction of plasticizers in the PSA may amount to more than 1 part by weight, more particularly 2 to 15 parts by weight, and preferably 3 to 10 parts by weight, based on 100 parts by weight of polyacrylate. As plasticizer it is possible to employ an individual compound or else a mixture of compounds. Through the use of plasticizers it is possible in particular to modify the bond strength of the PSA. The bond strength of the PSA may be lowered in particular by plasticizers, to below 1 N/cm, for example. One scenario in which this is advantageous is when the PSA is to be detached from the sensitive substrates on which substantial forces may not be exerted. Examples of such substrates are thin films or paper. By adding plasticizers, a reversible PSA with low bond strength can be obtained, even without structuring, that is suitable, for example, for optical applications, among others.

On account of the effective crosslinking by the alkyl groups R¹ of the monomers A, PSAs with plasticizers also generally exhibit good aging stability. This can be assisted further through use of plasticizers with long aliphatic chains, which exhibit high compatibility and miscibility with the polyacrylate.

Examples of plasticizers which can be used are polyethylene glycol or polypropylene glycol. These components may differ in the length of the glycol segments and also in the form of the termination. Use is made here in particular of polyglycols terminated with hydroxyl groups and with methoxy groups. Furthermore, plasticizers based on alkoxylated alkanoic acid can be used, especially with a chain of at least 8, more particularly 10 to 18, C atoms in length in the alkanoic acid moiety. The alkoxylated alkanoic acids may also have branched alkyl chains both in the acid radical and in the alkoxy group. The alkoxy radical preferably comprises alkyl groups having 1 to 10 C atoms. It is possible, furthermore, to make use in particular of isopropyl esters, especially those of carboxylic acids having 8 to 18 C atoms, examples being isopropyl undecanoate and isopropyl tetradecanoate.

According to a further embodiment, the plasticizers are selected from a group which encompasses polyethylene glycol, polypropylene glycol, alkoxylated alkanoic acid, isopropyl esters, and a combination thereof. They may be selected more particularly from isopropyl undecanoate, isopropyl tetradecanoate, and a combination thereof.

The PSA of the invention need not contain tackifying resins. Below a certain level of tackifying resins, however, the reversible adhesive properties may be lost, and a PSA becomes permanently adhesive. According to a further embodiment, therefore, the PSA comprises 0 or more but less than 20 parts by weight of tackifying resins per 100 parts by weight of polyacrylate.

According to a further embodiment, the PSA comprises, as additives, tackifying resins, which are present in a fraction of at least 0.01 and less than 20 parts by weight per 100 parts by weight of polyacrylate in the PSA. The PSA may comprise 0.1 to 15 parts by weight, more particularly 0.5 to 10 and preferably 1 to 8 parts by weight, of tackifying resins per 100 parts by weight of polyacrylate. PSAs of this kind are especially suitable for a comparatively strong and yet reversible bonding.

Tackifying resins have already been described in the literature and are also known per se to the skilled person by this term. They are polymers of one or more different monomers, the polymers having a comparatively low molecular weight and being able to enhance the adhesion properties of an adhesive. With regard to the tackifying resins, and particularly their preparation, reference is made to the “Handbook of pressure sensitive adhesive technology” by Donatas Satas (van Nostrand, 1989), the relevant disclosure content of which is hereby incorporated by reference. In principle there is no restriction on the selection of tackifying resins in accordance with the invention. An individual compound or a mixture of compounds can be used.

According to a further embodiment the tackifying resin has an average molecular weight of less than 4000 g/mol. In general the average molecular weight is at least 100 g/mol, as for example 500 to 3000 g/mol and more particularly 1000 to 2000 g/mol. The molecular weight is determined again by Test method A.

According to a further embodiment, the tackifying resin is selected from a group which encompasses pinene resins, indene resins, and rosins, and also their disproportionated, hydrogenated, polymerized or esterified derivatives and salts, aliphatic hydrocarbon resins, alkylaromatic hydrocarbon resins, aromatic hydrocarbon resins, terpene resins, terpene-phenolic resins, C5 and C9 hydrocarbon resins, which may be at least partly hydrogenated, natural resins and combinations thereof. Via the selection and/or combination of tackifying resins it is possible to fine-tune the properties of the PSA.

The compatibility of the polyacrylate with the tackifying resins is generally high. On account of its apolar character, however, the polyacrylate even with very apolar resins has a good compatibility which is not necessarily so with conventional polymers. Suitable for grading the polarity of the tackifying resins, for example, is the determination of the DACP (Diacetone Alcohol Cloud Point). The procedure here is analogous to ASTM D6038. The higher the DACP, the more apolar the tackifying resins and the poorer their compatibility with relatively polar polyacrylates. According to a further embodiment, tackifying resins are used which have a DACP of greater than 0° C., more particularly of greater than 20° C., and preferably of greater than 40° C.

The tackifying resin may be selected preferably from C5 and/or C9 hydrocarbon resins, which may be at least partly hydrogenated. These resins exhibit particularly high compatibility with the monomer A of the polyacrylate.

A higher degree of hydrogenation raises the DACP.

It has surprisingly been found, moreover, that polyacrylates with a high monomer A fraction of more than 50 wt % also—in spite of the shielding apolar groups—exhibit high compatibility with polar tackifying resins. Examples of polar tackifying resins are rosins. In general a high compatibility has also been found with polar tackifying resins which have a DACP of below −20° C. According to a further embodiment, the tackifying resins have a DACP of less than −20° C.

According to a further embodiment, the PSA comprises further additives, which are used at up to 40 parts by weight, more particularly 1 to 30 and preferably 2 to 20 parts by weight, per 100 parts by weight of polyacrylate. These further additives may for example be selected from a group which encompasses fillers, such as fibers, carbon black, zinc oxide, chalk, wollastonite, solid or hollow glass beads, microbeads, silica and silicates, for example, nucleating agents, electrically conductive materials, such as conjugated polymers, doped conjugated polymers, metal pigments, metal particles, metal salts, and graphite, for example, expandants, compounding agents, aging inhibitors, in the form for example of primary and secondary antioxidants or in the form of a light stabilizers, and combinations thereof.

As a further aspect of the application, a method is specified for producing a pressure-sensitive adhesive. According to at least one embodiment, the method comprises the steps of:
(A) producing a monomer mixture, said monomer mixture comprising
   a) 5 to 100 wt % of acrylic esters of the formula CR³₂═C(R²)(COOR¹) as monomers A, where R¹ is a branched alkyl group having 16 to 22 C atoms, and has at least two branching locations, R² is selected from H, methyl or halogen, and R³ independently at each occurrence is selected from H or halogen,
   b) 0 to 95 wt % of acrylic esters of the formula CR⁶₂═C(R⁵)(COOR⁴) as monomers B, where R⁴ is a linear, singly branched, cyclic or polycyclic alkyl group having 1 to 14 C atoms, R⁵ is selected from H, methyl or halogen, and R⁶ independently at each occurrence is selected from H or halogen,
   c) 0 to 5 wt % of monomers having at least one alcoholic hydroxyl group as monomers C,
   d) 0 to 5 wt % of monomers having at least one COOH group as monomers D,
   e) 0 to 5 wt % of monomers having at least one epoxy group as monomers E, and
   f) 0 to 2.5 wt % of monomers having at least one UV-activatable group as monomers F;
(B) polymerizing the monomer mixture to form polyacrylate;
(C) optionally admixing the polyacrylate with an additive and/or a crosslinker; and
(D) at least partly crosslinking a mixture obtained by step (B) and the optional step (C), to form the pressure-sensitive adhesive.

As a result of the method it is possible to produce a PSA according to at least one embodiment of the invention. The observations made above are therefore also valid for corresponding embodiments of the method, and, accordingly, details below may also be valid for a PSA of the invention.

Steps (A) to (D) are preferably carried out in that order; optionally, it is also possible for certain steps, (B) and (C), for example, to overlap in time, in other words to run in parallel. In step (B) it is possible in particular for predominantly linear polymer molecules to be formed, which are at least partly crosslinked with one another in step (D).

Step (C) is optional. This means that step (C) is carried out if at least one additive (as described above) and/or at least one crosslinker (as described later on below) is added. Additives are provided in certain embodiments of the PSA of the invention. In order to produce such embodiments, therefore, a step (C) is necessary. Step (C) may in principle also take place in a plurality of substeps. It is possible, for example, first to add additives and mix them in and then later, shortly before the crosslinking in step (D), preferably, to add one or more crosslinkers.

According to a further embodiment the polymerization (step (B)) is carried out in a solvent. Examples of solvents used may be water, a mixture of organic solvents, or a mixture of organic solvents and water. The aim here is generally to minimize the amount of solvent used. For this purpose the solvent can be admixed in step (A), for example.

The optional step (C) may also with preference be carried out partly or wholly in the solvent, since this facilitates thorough mixing. In this way the distribution of the components in the PSA can be particularly homogeneous.

Suitable organic solvents may be selected, for example, from a group which encompasses pure alkanes, as for example hexane, heptane, octane, and isooctane, aromatic hydrocarbons, as for example benzene, toluene, and xylene, esters, as for example ethyl acetate, and propyl, butyl or hexyl acetate, halogenated hydrocarbons, such as chlorobenzene, for example, alkanols, such as methanol, ethanol, ethylene glycol and ethylene glycol monomethyl ether, for example, ethers, such as diethyl ether and dibutyl ether, for example, and combinations thereof.

It is possible optionally to add a water-miscible or hydrophilic cosolvent in order to ensure that the reaction mixture is present in the form of a homogeneous phase during the crosslinking. Suitable cosolvents may be selected from a group which encompasses aliphatic alcohols, glycols, ethers, glycol ethers, pyrrolidines, N-alkylpyrrolidinones, N-alkylpyrrolidones, polyethylene glycols, polypropylene glycols, amides, carboxylic acid and salts thereof, esters, organosulfides, sulfoxides, sulfones, alcohol derivatives, hydroxyether derivatives, amino alcohols, ketones, and combinations thereof.

According to one further embodiment the solvent is removed in a further step (E). This may occur in particular through heating. The solvent can be removed, for example, in a drying oven or drying tunnel. The energy introduced may optionally be used for the (proportional) thermal crosslinking, i.e., thermal curing. Step (E) may accordingly take place before step (D), may overlap partly or wholly with step (D), or may correspond to step (D).

The polymerization (step (B)) may also take place without solvent, in other words in bulk. In that case it is in fact possible subsequently to add one of the aforementioned solvents or solvent mixtures for the optional step (C), but step (C) is then generally also carried out in the absence of solvents, for economic reasons.

Polymerization in bulk is suitable, for example, for producing hotmelt acrylate PSAs. In this case the prepolymerization technique is particularly appropriate. Polymerization in that case is initiated with UV light, but carried on only to a low conversion of about 10 to 30%. The resulting polymer syrup can be subsequently welded into films, for example, and then polymerized through to high conversion in water. These pellets can then be employed as acrylate hotmelt PSA, the film materials used for the melting process preferably being materials which are compatible with the polyacrylate.

According to a further embodiment the polyacrylate is liquefied by heating for the optional step (C). This makes it easier to mix, especially if polymerization has taken place without solvent. “Liquefied” here is intended to denote that a solid polyacrylate is melted or, in the case of a polyacrylate of low fluidity, the viscosity is greatly lowered. A mixing operation in the absence of solvent may take place, for example, in a suitable twin-screw extruder.

According to a further embodiment a radical polymerization is carried out in step (B). For polymerizations proceeding by a radical mechanism, it is preferable for initiator systems to be used that additionally comprise further radical initiators for the polymerization, especially thermally decomposing, radical-forming azo or peroxo initiators. Initiators can be added in step (A), for example. All customary initiators familiar for acrylates to the skilled person are suitable in principle. The generation of C-centered radicals is described in Houben Weyl, Methoden der Organischen Chemie, Vol. E 19a, pp. 60-147, the relevant disclosure content of which is hereby incorporated by reference. These methods may likewise be employed in the context of the patent application.

Examples of suitable radical sources are peroxides, hydroperoxides, and azo compounds. The radical initiators may be selected, for example, from a group which encompasses potassium peroxodisulfate, dibenzoyl peroxide, cumene hydroperoxide, cyclohexanone peroxide, di-tert-butyl peroxide, 2,2′-azodi(2-methylbutyronitrile), azodiisobutyronitrile, cyclohexylsulfonyl acetyl peroxide, diisopropyl percarbonate, tert-butyl peroctoate, benzopinacol, and a combination thereof. With preference it is possible to use 1,1′-azobis(cyclohexanecarbonitrile) (Vazo 88™ from DuPont) and/or azodiisobutyronitrile (AIBN).

The polymerization can be carried out for example in polymerization reactors, which in general are provided with a stirrer, a plurality of feed vessels, reflux condenser, heating, and cooling, and are equipped for operation under N₂ atmosphere and superatmospheric pressure.

In order to initiate the polymerization, for thermally decomposing initiators, heat can be introduced. For thermally decomposing initiators the polymerization can be initiated by heating to 50° C. to 160° C., depending on initiator type.

The polymerization time in step (B) may be between 2 and 72 hours, depending on conversion and temperature. The higher the reaction temperature that can be selected, in other words the higher the thermal stability of the reaction mixture, the lower the level at which, in general, the reaction time can be selected.

The polymerization takes place generally in such a way that for the polyacrylate an average molecular weight of 50 000 to 4 000 000 g/mol, more particularly 100 000 to 3 000 000 g/mol, and preferably 400 000 to 1 400 000 g/mol is obtained.

A comparatively low molecular weight or a comparatively narrow molecular weight distribution can be obtained by adding, for the crosslinking, chain transfer agents, known to regulate polymerization or as control reagents. These agents are particularly suitable for radical crosslinking.

Examples of chain transfer agents that can be added include alcohols, aromatics, such as, for example, toluene, ethers, dithioethers, dithiocarbonates, trithiocarbonates, nitroxides, alkyl bromides, thiols, and TEMPO and TEMPO derivatives.

In a further refinement, chain transfer agents used are control reagents of the general formula (I) and/or (II):

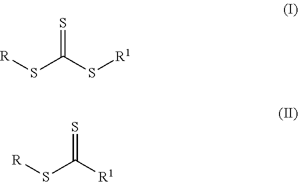

In these formulae, R and R¹ may be selected independently of one another as
branched and unbranched C₁ to C₁₈ alkyl radicals, C₃ to C₁₈ alkenyl radicals, C₃ to C₁₈ alkynyl radicals,
C₁ to C₁₈ alkoxy radicals,
C₁ to C₁₈ alkyl radicals, C₃ to C₁₈ alkenyl radicals, and C₃ to C₁₈ alkynyl radicals, substituted by at least one OH group or halogen atom or silyl ether,
C₂-C₁₈ hetero-alkyl radicals having at least one O atom and/or an NR* group in the carbon chain, where R* may be any desired (in particular organic) radical,
C₁ to C₁₈ alkyl radicals, C₃ to C₁₈ alkenyl radicals, and C₃ to C₁₈ alkynyl radicals, substituted by at least one ester group, amino group, carbonate group, cyano group, isocyano group and/or epoxide group and/or by sulfur,
C₃-C₁₂ cycloalkyl radicals,
C₆-C₁₈ aryl or benzyl radicals,
hydrogen.

Control reagents of type (I) and (II) preferably contain the following compounds or substituents:

Halogen atoms here are preferably F, Cl, Br or I, more preferably CI and Br. Suitable alkyl, alkenyl, and alkynyl radicals in the various substituents include both linear and branched chains.

Examples of alkyl radicals which contain 1 to 18 carbon atoms, are methyl, ethyl, propyl, isopropyl, butyl, isobutyl, tert-butyl, pentyl, 2-pentyl, hexyl, heptyl, octyl, 2-ethylhexyl, tert-octyl, nonyl, decyl, undecyl, tridecyl, tetradecyl, hexadecyl, and octadecyl.

Examples of alkenyl radicals having 3 to 18 carbon atoms are propenyl, 2-butenyl, 3-butenyl, isobutenyl, n-2,4-pentadienyl, 3-methyl-2-butenyl, n-2-octenyl, n-2-dodecenyl, isododecenyl, and oleyl.

Examples of alkynyl having 3 to 18 carbon atoms are propynyl, 2-butynyl, 3-butynyl, n-2-octynyl, and n-2-octadecynyl.

Examples of hydroxy-substituted alkyl radicals are hydroxypropyl, hydroxybutyl, or hydroxyhexyl.

Examples of halogen-substituted alkyl radicals are dichlorobutyl, monobromobutyl, or trichlorohexyl.

A suitable C₂-C₁₈ hetero-alkyl radical having at least one O atom in the carbon chain is, for example, —CH₂—CH₂—O—CH₂—CH₃.

Serving as C₃-C₁₂ cycloalkyl radicals are, for example, cyclopropyl, cyclopentyl, cyclohexyl, or trimethylcyclohexyl.

Serving as C₆-C₁₈ aryl radicals are, for example, phenyl, naphthyl, benzyl, 4-tert-butylbenzyl or other substituted phenyl, such as, for example, ethyl, toluene, xylene, mesitylene, isopropylbenzene, dichlorobenzene, or bromotoluene.

It is also possible, furthermore, to use compounds of the types (III) and (IV) below as control reagents

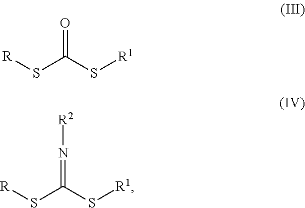

where R² likewise, and independently of R and R¹, may be selected from the groups listed above for these radicals.

In a conventional “RAFT process”, polymerization is usually taken only to low conversions (WO 98/01478 A1), in order to produce molecular weight distributions that are extremely narrow. As a result of the low conversions, however, these polymers cannot be used as PSAs, since the high proportion of residual monomers is detrimental to the technical adhesive properties. Preferably, therefore, the abovementioned control reagents, optionally, are used as chain transfer agents, thus producing a bimodal molecular weight distribution. By means of very efficient chain transfer agents, moreover, it is possible to restrict the molecular weight distribution (narrower distribution), with beneficial consequences in turn for the profile of technical adhesive properties.

As further chain transfer agents it is possible to use nitroxides. Radical stabilization takes place using, for example, nitroxides of type (Va) or (Vb):

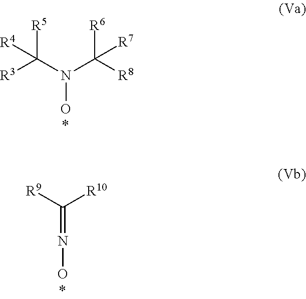

where R³, R⁴, R⁵, R⁶, R⁷, R⁸, R⁹, and R¹⁰ independently of one another denote the following compounds or atoms:

i) halides, as for example chlorine, bromine or iodine,

ii) linear, branched, cyclic, and heterocyclic hydrocarbons having 1 to 20 carbon atoms, which may be saturated, unsaturated or aromatic,

iii) esters —COOR¹¹, alkoxides —OR¹² and/or phosphonates —PO(OR¹³)₂,

where R¹¹, R¹² or R¹³ are radicals from group ii).

Compounds of types (Va) or (Vb) may also be attached to polymer chains of any kind, primarily such that at least one of the abovementioned radicals constitutes a polymer chain of this kind, and hence are also utilized for the construction of the PSAs.

Further suitable chain transfer agents for the polymerization are compounds of the following type:
2,2,5,5-tetramethyl-1-pyrrolidinyloxyl (PROXYL), 3-carbamoyl-PROXYL, 2,2-dimethyl-4,5-cyclohexyl-PROXYL, 3-oxo-PROXYL, 3-hydroxylimine-PROXYL, 3-aminomethyl-PROXYL, 3-methoxy-PROXYL, 3-tert-butyl-PROXYL, 3,4-di-tert-butyl-PROXYL,
2,2,6,6-tetramethyl-1-piperidinyloxy pyrrolidinyloxy (TEMPO), 4-benzoyloxy-TEMPO, 4-methoxy-TEMPO, 4-chloro-TEMPO, 4-hydroxy-TEMPO, 4-oxo-TEMPO, 4-amino-TEMPO, 2,2,6,6-tetraethyl-1-piperidinyloxyl, 2,2,6-trimethyl-6-ethyl-1-piperidinyloxyl,
N-tert-butyl 1-phenyl-2-methylpropyl nitroxide,
N-tert-butyl 1-(2-naphthyl)-2-methylpropyl nitroxide,
N-tert-butyl 1-diethylphosphono-2,2-dimethylpropyl nitroxide,
N-tert-butyl 1-dibenzylphosphono-2,2-dimethylpropyl nitroxide,
N-(1-phenyl-2-methylpropyl) 1-diethylphosphono-1-methylethyl nitroxide,
di-tert-butyl nitroxide,
diphenyl nitroxide, and
tert-butyl tert-amyl nitroxide.

It may be of advantage, moreover, for the purpose of increasing the conversion, to add an initiator which possesses a crosslinking efficiency of more than 5. Such initiators are, for example, Perkadox 16 from Akzo Nobel.

According to a further embodiment, an anionic polymerization is carried out in step (B). In this case in general a reaction medium is used, more particularly one or more inert solvents. Examples of such solvents are aliphatic and cycloaliphatic hydrocarbons or else aromatic hydrocarbons.

The living polymer in this case is represented in general by the structure P_{L}(A)-Me, where Me is a metal from group I, such as lithium, sodium or potassium, for example, and P_{L}(A) is a growing polymer block of the monomers A. The molar mass of the polymer under preparation is controlled by the ratio of initiator concentration to monomer concentration. Examples of suitable polymerization initiators include n-propyllithium, n-butyllithium, sec-butyllithium, 2-naphthyllithium, cyclohexyllithium or octyllithium. It is possible, furthermore, to use initiators based on samarium complexes for the polymerization, as described in Macromolecules, 1995, 28, 7886, the relevant disclosure content of which is hereby incorporated by reference. Furthermore it is also possible to use difunctional initiators, such as 1,1,4,4-tetraphenyl-1,4-dilithiobutane or 1,1,4,4-tetraphenyl-1,4-dilithioisobutane, for example. Coinitiators may likewise be used. Suitable coinitiators include lithium halides, alkali metal alkoxides or alkylaluminum compounds.

According to a further embodiment, the crosslinking takes place in step (D) by means of irradiation with UV radiation, by means of irradiation with an ionizing radiation, thermally, or through a combination thereof.

Crosslinking may be accomplished in particular by means of UV radiation or of ionizing radiation, as for example electron beams. It may involve, for example, short-term irradiation with UV radiation in the range from 200 to 400 nm using commercial high-pressure or medium-pressure mercury lamps with an output of, for example, 80 to 240 W/cm, or with ionizing radiation, such as electron beams, for example.

Optionally it is possible, additionally or else alternatively to this, for a thermal curing step to take place. This may occur, for example during the removal of solvent or else in bulk.

According to one further embodiment, crosslinkers are added in step (C). This may take place in particular shortly before step (D), in which the crosslinkers take effect. The choice of the crosslinkers is guided in particular by the nature of the crosslinking.

Examples of suitable crosslinkers for electron beam crosslinking or UV crosslinking are di- or polyfunctional acrylates, di- or polyfunctional isocyanates (including those in blocked form), or di- or polyfunctional epoxides. They are added typically in amounts between 0.1 and 5 parts by weight, more particularly between 0.2 and 3 parts by weight, based on 100 parts by weight of polyacrylate.

According to a further embodiment, thermally activatable crosslinkers are used that are selected from a group which encompasses Lewis acids, metal chelates, metal salts, di- or polyfunctional epoxides, di- or polyfunctional isocyanates, and a combination thereof. Examples of metal chelates are aluminum chelate, as for example aluminum(III) acetylacetonate, or titanium chelate.

The degree of crosslinking in the case of thermal crosslinking may be controlled for example through the amount of the crosslinker added. For example, for polyacrylates with a high elastic component, preference is given to adding more than 0.5 part by weight, more particularly more than 0.75 part by weight, of metal chelate or epoxy compound or isocyanate compound, based on 100 parts by weight of polyacrylate base polymer. With preference more than 1.0 part by weight is used. Generally speaking not more than 10 parts by weight of crosslinker should be added, in order to avoid complete “vitrification”.

For possible crosslinking with UV radiation it is possible to use free UV-absorbing photoinitiators, these being photoinitiators which do not, in analogy to monomer C, carry one or more double bonds and cannot be incorporated into the polymer by copolymerization. There is no need for such photoinitiators if monomers F are used. Also possible, however, is a combination of free photoinitiators and monomer F in the polyacrylate.

Examples of suitable photoinitiators are benzoin ethers, such as benzoin methyl ether and benzoin isopropyl ether, for example, substituted acetophenones, such as 2,2-diethoxyacetophenone (available as Irgacure 651® from Ciba Geigy), 2,2-dimethoxy-2-phenyl-1-phenylethanone, and dimethoxyhydroxyacetophenone, for example, substituted α-ketols, such as 2-methoxy-2-hydroxypropiophenone, for example, aromatic sulfonyl chlorides, such as 2-naphthylsulfonyl chloride, for example, and photoactive oximes, such as 1-phenyl-1,2-propanedione 2-(O-ethoxycarbonyl)oxime, for example.

The photoinitiators mentioned above and others which can be used, and others of the Norrish I or Norrish II type, may contain, for example, the following substituents: benzophenone-, acetophenone-, benzil-, benzoin-, hydroxyalkylphenone-, phenyl cyclohexyl ketone-, anthraquinone-, trimethylbenzoylphosphine oxide-, methylthiophenyl morpholinyl ketone-, aminoketone-, azobenzoin-, thioxanthone-, hexarylbisimidazole-, triazine-, or fluorenone, it being possible for each of these radicals additionally to be substituted by one or more halogen atoms and/or one or more alkyloxy groups and/or one or more amino groups or hydroxyl groups. A representative overview is provided by Fouassier: “Photoinitiation, photopolymerization and photocuring: Fundamentals and applications”, Hanser-Verlag, Munich 1995, the relevant disclosure content of which is hereby incorporated by reference. Reference is further made to Carroy et al. in “Chemistry and technology of UV and EB formulation for coatings, inks and paints”, Oldring (Ed.), 1994, SITA, London, the relevant disclosure content of which is hereby incorporated by reference.

Indicated as a further aspect of the patent application is the production of an adhesive tape. At least according to one embodiment, the method for producing the adhesive tape can be integrated into the method of the invention for producing a pressure-sensitive adhesive. It may therefore also be regarded as further embodiment(s) of the method for producing a pressure-sensitive adhesive. According to at least one embodiment, for producing an adhesive tape, where the adhesive tape comprises a PSA according to at least one embodiment of the invention, and a carrier, the carrier is provided with the PSA.

According to a further embodiment, the carrier is provided with the PSA by applying the mixture, obtained after step (B) and also after optional step (C), to the carrier and subsequently carrying out crosslinking in step (D). Application takes place more particularly in layer form, thus forming an adhesive layer. The carrier may be a permanent or temporary carrier.

In further, optional method steps, the adhesive tape may be provided with further pressure-sensitively adhesive layers, possibly including those of the invention. It is possible optionally for further carriers to be introduced in the adhesive tape. It is also possible optionally for further steps known to the skilled person, such as the trimming of the adhesive tape, for example, to take place.

As a further aspect of the patent application, an adhesive tape is indicated. The adhesive tape comprises a carrier and a PSA, which is a PSA according to at least one embodiment of the invention. The PSA may be applied in layer form, more particularly directly, on the carrier. It may be part of an adhesive layer or may form such a layer entirely. It preferably forms an adhesive layer completely. An adhesive layer may wholly or partly cover one side of the carrier. For reversible adhesive bonds, as has already been described above, the PSA is advantageously left unstructured.

As carriers it is possible in principle to use permanent and/or temporary carriers. Permanent carriers are retained in the adhesive tape, whereas temporary carriers are removed for bonding. They are employed primarily in order to protect and to transport the adhesive tape.

Suitable permanent carriers include in principle all materials known to the skilled person. They may be selected, for example, from films, based for example on polyester, PET, PE, PP, BOPP or PVC, or from nonwovens, foams, woven fabrics, and woven-fabric films.

In the case of reversible PSAs, moreover, the anchoring of the adhesive on the permanent carrier is of great importance. It ought to be higher on the permanent carrier than to the substrate. In the course of the invention it has been found that the PSAs of the invention develop better anchoring as a result of physical pretreatment on the carrier. Increasing the polarity of the carrier was particularly advantageous. Use is made more particularly of permanent carriers which after pretreatment have a surface energy of greater than 60 dyn/cm², preferably of greater than 72 dyn/cm². This is done for example by means of pretreatment by corona, plasma, chemical etching. Alternatively it is also possible to use adhesion promoters which are able to form chemical bonds to the inventive polyacrylate.

The surface tension (surface energy) can be determined according to DIN ISO 8296. For this purpose it is possible for example to use test inks from Softal. The inks are available in the range from 30 to 72 mN/m. The ink is applied with a line of ink to the surface. If the line of ink contracts in less than 2 seconds, the measurement is repeated with an ink of lower surface tension. If the ink coating remains unchanged for longer than 2 seconds, the measurement is repeated with an ink of higher surface tension until the 2 seconds are reached. The figure indicated on the bottle at that point corresponds to the surface energy of the film.

In a further variant, the surface of the carrier material can be roughened and in this way the anchoring improved via physical effects. One example of this is blasting with sand.

Suitable temporary carriers include in principle all materials known to the skilled person. They may be selected, for example, from release paper, based for example on glassine, HDPE or LDPE, from release films, based for example on PET, MOPP or PE, or from other antiadhesively furnished materials, such as siliconized or PE-coated papers or films, for example.

According to a further embodiment, the adhesive tape comprises only one adhesive layer, with this adhesive layer comprising or consisting of the PSA of the invention. Adhesive tapes in this embodiment may comprise preferably two temporary carriers, as described above, these carriers optionally being selected independently of one another, and so the adhesive tape takes the form of what is called an adhesive transfer tape. The carriers are preferably disposed on opposite sides of the PSA, allowing the adhesive transfer tape, after it has been wound, to be unwound again. In the case of an adhesive transfer tape, only the PSA is generally left after bonding. The adhesive tape of the invention can therefore take the form of an adhesive transfer tape.

The coat weight of the PSA and the basis weight of a temporary carrier may vary depending on the direction of use. The coat weight of the PSA may be, for example, between 5 and 250 g/m², more particularly 15 to 150 g/m². Release films may have a layer thickness, for example, of 5 to 175 μm. The basis weight of release papers may amount, for example, to between 50 and 150 g/m².

According to a further embodiment, the adhesive tape comprises two or more, more particularly two, adhesive layers, of which at least one comprises or consists of a PSA according to at least one embodiment of the invention.

In the case of adhesive tapes in this embodiment, a permanent carrier is preferably used. This carrier may be coated on one side, partly or fully, with a PSA of the invention. Generated wholly or partly on the opposite side is a further adhesive layer. This layer may likewise comprise or consist of a PSA of the invention having identical or different properties, or else may be a conventional adhesive layer. For certain applications, adhesive tapes with two different adhesive layers are advantageous. For example, a combination of a strongly, largely irreversibly adhering adhesive layer and of a reversibly adhering, adhesive layer of the invention may be advantageous.

On the side facing away from the permanent carrier, the adhesive layers may be provided with a temporary carrier. By this means the adhesive tape can be wound and unwound again, for example.

For double-sided pressure-sensitive adhesive tapes it is possible for example to use filmic carriers having a thickness of 5 to 200 μm. PET in particular is a film material used. Use may also be made of PVC, PE, PP, PMMA, polyimide, PEN, or other films familiar to the skilled person.

The layer thickness of a PSA may also vary according to chemical composition and to the level of bond strength required. In order to achieve good reversibilities, an adhesive layer composed of a PSA of the invention may have, for example, a layer thickness of between 5 and 100 μm. For applications as reversible pressure-sensitive adhesive tapes, the two sides may also differ in respect of the layer thickness.

As a further aspect of the patent application, the use of a PSA is indicated. A PSA according to at least one embodiment of the invention is used in painting operations, for surface protection applications, for optical applications, and in the electronics sector, more particularly for producing or repairing electronic devices.

A PSA of the invention can be used in painting operations. For this use, the PSA is preferably part of an adhesive tape. Following a painting procedure, the adhesive tape can then be removed without residue.

A PSA of the invention can be used in surface protection applications. Here the PSA and/or an adhesive tape produced from it is used, for example, for temporary mechanical protection. This may be the case, for example, in production operations where avoiding the scratching of a component is desirable, for example. The protection may also involve protection from radiation, such as insolation, for example, in order to prevent UV-induced yellowing, for example.

A PSA of the invention can be used in the area of electronics or the electronics industry. Here, for example, as part of production, electronic components can be parted from one another again after bonding. The reasons for this may be incorrect adjustments to the components, or errors in functional testing. Another field is that of repairs. Electronic devices, such as, for example, cell phones, tablet PCs, solutions intermediate between cell phones and tablet PCs, as for example so-called smart phones, and also notebooks may be destroyed if improperly treated. This necessitates the replacement of individual components. Advantageous here in principle as well are pressure-sensitive adhesive tapes which can be removed without residue, thereby reducing the repair time as a result of absence of solvents for removing residues of PSA. The pressure-sensitive adhesive tapes of the invention can also be used in a repositioning sense. This operation likewise concerns a multiplicity of primarily manual applications where precise positioning is a factor. Here it is an advantage that the adhesive tape of the invention can be removed without residue or destruction and applied again.

Indicated as a further aspect of the patent application is the use of monomers. An acrylic ester of the formula CR³₂═C(R²)(COOR¹) is used for producing a pressure-sensitive adhesive which is suitable for reversible bonding, with R¹ being a branched alkyl group having 16 to 22 C atoms and having at least two branching locations, R² being selected from H, methyl or halogen, and R³, in each case independently of one another, being selected from H or halogen.

Test Methods

For the characterization of polyacrylates and/or the pressure-sensitive adhesives, it is possible to use the test methods set out below.

Gel Permeation Chromatography (GPC) (Test A):

The average molecular weight M_{w} and the polydispersity PD were determined in the eluent THF with 0.1 vol % trifluoroacetic acid (vol %=percent by volume). Measurement took place at 25° C. The pre-column used was PSS-SDV, 5 μm, 10³ Å,

ID 8.0 mm×50 mm. Separation took place using the columns PSS-SDV, 5 μm, 10³ Å and also 10⁵ Å and 10⁶ Å each with ID 8.0 mm×300 mm (1 Å=10′ m). The sample concentration was 4 g/I, the flow rate 1.0 ml per minute. Measurement took place against PMMA standards.

Rheometer Measurements (Test B).

The measurements for determining the tan δ were carried out with a RDA II rheometer from Rheometrics Dynamic Systems in plate-on-plate configuration. Measurement took place on a circular sample having a sample diameter of 8 mm and a sample thickness of 1 mm.

The circular sample was punched from a carrier-free adhesive film 1 mm thick. Measuring conditions: temperature sweep from −30° C. to 130° C. at 10 rad/s.

180° Bond Strength Test (Test C):

The 180° bond strength is measured according to PSTC-1. A strip 20 mm wide of a PSA applied to polyester was applied to a defined substrate plaque. The PSA strip was pressed twice onto the substrate using a 2 kg weight. The adhesive tape was subsequently peeled from the substrate immediately at 300 mm/min and at a 180° angle. The results of measurement are reported in N/cm and are averages from three measurements. All measurements were conducted at room temperature under established conditions (23° C., 50% relative humidity).

180° Bond Strength Test—Peel Increase (Test D):

The peel strength (bond strength) was tested according to PSTC-1. A PET film 25 μm thick has a pressure-sensitively adhesive layer 50 μm thick applied to it. A strip of this specimen 2 cm in width is adhered to a PE plaque lined with graphic paper (copying paper from ROTOKOP, 80 g/m²), by being rolled over back and forth three times with a 2 kg roller. After 72 hours of bonding, the plaque is clamped in and the self-adhesive strip is peeled off via its free end in a tensile testing machine at a peel angle of 180° and a velocity of 300 mm/min.

Reversibility (Test E):

A PET film 25 μm thick has a pressure-sensitively adhesive layer 50 μm thick applied to it. A strip of this specimen 2 cm in width, with a length of 15 cm, is folded over on itself and bonded by being rolled over back and forth three times using a 2 kg roller.

Immediately thereafter the adhesive surfaces are parted from one another by hand, the reversibility of the individual samples being assessed by the choice of removal rate. The test is passed if the pressure-sensitively adhesive films can be parted from one another without damage and without great expenditure of force.

### EXAMPLES

The examples which follow serve to elucidate the content of the patent application in more detail, without any intention that the selection of the examples should restrict the content of the patent application in any way.

### Example 1

### PSA 1

A 2 L glass reactor conventional for radical polymerizations was charged with 8 g of acrylic acid, 196 g of 2-ethylhexyl acrylate, 196 g of a mixture of monomers A for which R²═R³═H and R¹ is a C17 alkyl chain having three branching sites and the glass transition temperature of the homopolymer is −72° C., 133 g of special-boiling-point spirit 69/95, and 133 g of acetone. After nitrogen gas had been passed through the reaction solution for 45 minutes with stirring, the reactor was heated to 58° C. and 0.2 g of 2,2′-azodi(2-methylbutyronitrile) (Vazo 67™, from DuPont) was added. The external heating bath was then heated to 75° C. and the reaction was carried out constantly at this external temperature. After a reaction time of 1 hour, 20 g of isopropanol were added. After 2.5 hours the batch was diluted with 100 g of acetone. After a reaction time of 4 hours, a further 0.2 g of Vazo 67™ was added. After a polymerization time of 7 hours, dilution took place with 100 g of special-boiling-point spirit 60/95, and after 22 hours with 100 g of acetone. After a reaction time of 24 hours, the polymerization was discontinued and the reaction vessel was cooled to room temperature. The polymer was analyzed by Test method A. The molecular weight was 718 000 g/mol.

The polymer was blended in solution, with stirring with 0.3 wt % of aluminum(III) acetylacetonate. The PSA mixture is applied from solution with a solids content of 28% to a Saran-primed PET film 23 μm thick, and dried at 120° C. for 10 minutes. The coat weight after drying was 50 g/m².

### Example 2

### PSA 2

A 2 L glass reactor conventional for radical polymerizations was charged with 8 g of acrylic acid, 392 g of a mixture of monomers A for which R²═R³═H and R¹ is a C17 alkyl chain having three branching sites and the glass transition temperature of the homopolymer is −72° C., 133 g of special-boiling-point spirit 69/95, and 133 g of acetone. After nitrogen gas had been passed through the reaction solution for 45 minutes with stirring, the reactor was heated to 58° C. and 0.2 g of Vazo 67™ (from DuPont) was added. The external heating bath was then heated to 75° C. and the reaction was carried out constantly at this external temperature. After a reaction time of 1 hour, 20 g of isopropanol were added. After 2.5 hours the batch was diluted with 100 g of acetone. After a reaction time of 4 hours, a further 0.2 g of Vazo 67™ was added. After a polymerization time of 7 hours, dilution took place with 100 g of special-boiling-point spirit 60/95, and after 22 hours with 100 g of acetone. After a reaction time of 24 hours, the polymerization was discontinued and the reaction vessel was cooled to room temperature. The polymer was analyzed by Test method A. The molecular weight was 674 000 g/mol.

The polymer was blended in solution, with stirring with 0.3 wt % of aluminum(III) acetylacetonate. The PSA mixture is applied from solution with a solids content of 28% to a Saran-primed PET film 23 μm thick, and dried at 120° C. for 10 minutes. The coat weight after drying was 50 g/m².

### Example 3

### PSA 3

A 2 L glass reactor conventional for radical polymerizations was charged with 4 g of acrylic acid, 8 g of glycidyl methacrylate, 388 g of a mixture of monomers A for which R²═R³═H and R¹ is a C17 alkyl chain having three branching sites and the glass transition temperature of the homopolymer is −72° C., 133 g of special-boiling-point spirit 69/95, and 133 g of acetone. After nitrogen gas had been passed through the reaction solution for 45 minutes with stirring, the reactor was heated to 58° C. and 0.2 g of Vazo 67™ (from DuPont) was added. The external heating bath was then heated to 75° C. and the reaction was carried out constantly at this external temperature. After a reaction time of 1 hour, 20 g of isopropanol were added. After 2.5 hours the batch was diluted with 100 g of acetone. After a reaction time of 4 hours, a further 0.2 g of Vazo 67™ was added. After a polymerization time of 7 hours, dilution took place with 100 g of special-boiling-point spirit 60/95, and after 22 hours with 100 g of acetone. After a reaction time of 24 hours, the polymerization was discontinued and the reaction vessel was cooled to room temperature. The polymer was analyzed by Test method A. The molecular weight was 641 000 g/mol.

The polymer was blended in solution, with stirring with 0.15 wt % of zinc chloride and 0.4 wt % of Desmodur L 75 (Bayer SE, trifunctional isocyanate). The PSA mixture is applied from solution with a solids content of 28% to a Saran-primed PET film 23 μm thick, and dried at 120° C. for 10 minutes. The coat weight after drying was 50 g/m2.

### Example 4

### PSA 4

A 2 L glass reactor conventional for radical polymerizations was charged with 8 g of 2-hydroxyethyl acrylate, 196 g of 2-ethylhexyl acrylate, 196 g of a mixture of monomers A for which R²═R³═H and R¹ is a C17 alkyl chain having three branching sites and the glass transition temperature of the homopolymer is −72° C., 133 g of special-boiling-point spirit 69/95, and 133 g of acetone. After nitrogen gas had been passed through the reaction solution for 45 minutes with stirring, the reactor was heated to 58° C. and 0.2 g of Vazo 67™ (from DuPont) was added. The external heating bath was then heated to 75° C. and the reaction was carried out constantly at this external temperature. After a reaction time of 1 hour, 20 g of isopropanol were added. After 2.5 hours the batch was diluted with 100 g of acetone. After a reaction time of 4 hours, a further 0.2 g of Vazo 67™ was added. After a polymerization time of 7 hours, dilution took place with 100 g of special-boiling-point spirit 60/95, and after 22 hours with 100 g of acetone. After a reaction time of 24 hours, the polymerization was discontinued and the reaction vessel was cooled to room temperature. The polymer was analyzed by Test method A. The molecular weight was 739 000 g/mol.

The polymer was blended in solution, with stirring with 0.4 wt % Desmodur N75 (Bayer SE, trifunctional isocyanate). The PSA mixture is applied from solution with a solids content of 28% to a Saran-primed PET film 23 μm thick, and dried at 120° C. for 10 minutes. The coat weight after drying was 50 g/m².

### Example 5

### PSA 5

A 2 L glass reactor conventional for radical polymerizations was charged with 8 g of acrylic acid, 392 g of a mixture of monomers A for which R²═R³═H and R¹ is a C17 alkyl chain having three branching sites and the glass transition temperature of the homopolymer is −72° C., 133 g of special-boiling-point spirit 69/95, and 133 g of acetone. After nitrogen gas had been passed through the reaction solution for 45 minutes with stirring, the reactor was heated to 58° C. and 0.2 g of Vazo 67™ (from DuPont) was added. The external heating bath was then heated to 75° C. and the reaction was carried out constantly at this external temperature. After a reaction time of 1 hour, 20 g of isopropanol were added. After 2.5 hours the batch was diluted with 100 g of acetone. After a reaction time of 4 hours, a further 0.2 g of Vazo 67™ was added. After a polymerization time of 7 hours, dilution took place with 100 g of special-boiling-point spirit 60/95, and after 22 hours with 100 g of acetone. After a reaction time of 24 hours, the polymerization was discontinued and the reaction vessel was cooled to room temperature. The polymer was analyzed by Test method A. The molecular weight was 674 000 g/mol.

The polymer was blended in solution, with stirring with 2% of isopropyl undecanoate, 3.5 wt % of polypropylene glycol P1200 (molecular weight Mₙ=1200 g/mol, from Aldrich), and 0.5 wt % of Desmodur L75 (trifunctional isocyanate, Bayer SE). The PSA mixture is applied from solution with a solids content of 28% to a Saran-primed PET film 23 μm thick, and dried at 120° C. for 10 minutes. The coat weight after drying was 50 g/m².

### Example 6

### PSA 6

A 2 L glass reactor conventional for radical polymerizations was charged with 8 g of acrylic acid, 196 g of 2-ethylhexyl acrylate, 196 g of a mixture of monomers A for which R²═R³═H and R¹ is a C17 alkyl chain having three branching sites and the glass transition temperature of the homopolymer is −72° C., 133 g of special-boiling-point spirit 69/95, and 133 g of acetone. After nitrogen gas had been passed through the reaction solution for 45 minutes with stirring, the reactor was heated to 58° C. and 0.2 g of Vazo 67™ (from DuPont) was added. The external heating bath was then heated to 75° C. and the reaction was carried out constantly at this external temperature. After a reaction time of 1 hour, 20 g of isopropanol were added. After 2.5 hours the batch was diluted with 100 g of acetone. After a reaction time of 4 hours, a further 0.2 g of Vazo 67™ was added. After a polymerization time of 7 hours, dilution took place with 100 g of special-boiling-point spirit 60/95, and after 22 hours with 100 g of acetone. After a reaction time of 24 hours, the polymerization was discontinued and the reaction vessel was cooled to room temperature. The polymer was analyzed by Test method A. The molecular weight was 718 000 g/mol.

The polymer was blended in solution, with stirring with 0.3 wt % aluminum(III) acetylacetonate and 10% of Sylvares® TP105P (terpene-phenolic resin from Arizawa, softening range between 102 and 108° C.). The PSA mixture is applied from solution with a solids content of 28% to a Saran-primed PET film 23 μm thick, and dried at 120° C. for 10 minutes. The coat weight after drying was 50 g/m2.

### Comparative Example 1

### Reference PSA 1

A 2 L glass reactor conventional for radical polymerizations was charged with 48 g of acrylic acid, 352 g of 2-ethylhexyl acrylate, 133 g of special-boiling-point spirit 69/95, and 133 g of acetone. After nitrogen gas had been passed through the reaction solution for 45 minutes with stirring, the reactor was heated to 58° C. and 0.2 g of Vazo 67™ (from DuPont) was added. The external heating bath was then heated to 75° C. and the reaction was carried out constantly at this external temperature. After a reaction time of 2.5 hours, the batch was diluted with 100 g of acetone. After a reaction time of 4 hours, a further 0.2 g of Vazo 67™ was added. After a polymerization time of 5 hours, dilution took place with 100 g of acetone, after 6 hours with 100 g of special-boiling-point spirit 60/95. After a reaction time of 24 hours, the polymerization was discontinued and the reaction vessel was cooled to room temperature. The polymer was analyzed by Test method A. The molecular weight was 817 000 g/mol.

The polymer was blended in solution, with stirring with 0.1 wt % of aluminum(III) acetylacetonate. The PSA mixture is applied from solution with a solids content of 28% to a Saran-primed PET film 23 μm thick, and dried at 120° C. for 10 minutes. The coat weight after drying was 50 g/m².

The results are summarized below:

First of all the degree of crosslinking of all the samples was ascertained. For this method, the procedure of test method B was used, and rheometric measurements were conducted. The results are summarized in table 1.

TABLE 1

| Example | tan δ (Test B) |
|---|---|
| 1 | 0.40 |
| 2 | 0.41 |
| 3 | 0.37 |
| 4 | 0.42 |
| 5 | 0.67 |
| 6 | 0.45 |
| Comparative | 0.68 |
| example 1 | |

All of the inventive examples have a value for tan δ in the range of 0.37 and 0.67 and are therefore situated within an advantageous range. PSA 5 contains plasticizer and has a comparatively high tan δ value. With comparative example 1, a specimen was likewise selected which has a similar value. The tan δ influences not only the flow-on behavior, through the viscous component, but also the internal cohesion of the PSA, through the elastic component. The inventive examples have values for tan δ that are not too low. With a very low tan δ, the risk exists that a PSA may be split cohesively.

In order to examine whether the inventive examples can also be used as PSAs, Test C was carried out first of all to determine the direct bond strength (abbreviated to BS) to steel. The results are summarized in table 2.

TABLE 2

| | BS to steel instantaneous |
|---|---|
| Example | [N/cm] (Test C) |
| 1 | 3.0 |
| 2 | 2.9 |
| 3 | 2.8 |
| 4 | 3.1 |
| 5 | 0.3 |
| 6 | 3.7 |

All of the inventive examples exhibit PSA properties. Example 5 contains plasticizer and shows a very low level of bond strength. A bond strength level of this kind is representative, for example, of protective film bonds. Inventive example 6 comprises a tackifying resin and exhibits a higher bond strength level.

In order to simulate temporary bonds, the inventive examples were adhered to a variety of substrates. Substrates selected were as follows: steel, polyethylene terephthalate (PET) and polycarbonate (PC). These substrates are generally considered to be polar and therefore offer the possibility of development of a high bonding strength. As well as the bond strength, evaluation also took place to determine whether residues remain on the substrate after the removal of the adhesive tape. The results are summarized in table 3.

TABLE 3

| | BS to steel | BS to PC | BS to PET |
|---|---|---|---|
| | after 72 h | after 72 h | after 72 h |
| Example | [N/cm] (Test D) | [N/cm] (Test D) | [N/cm] (Test D) |
| 1 | 3.5* | 5.9* | 2.9* |
| 2 | 3.3* | 5.5* | 2.8* |
| 3 | 3.2* | 5.4* | 2.8* |
| 4 | 3.6* | 5.6* | 3.0* |
| 5 | 0.4* | 0.5* | 0.3* |
| 6 | 4.2* | 6.6* | 3.5* |

*No residues on the substrate.

From inventive examples 1 to 6 it is apparent that in no case are there residues remaining on the substrate (marked “*”). The PSAs can therefore be removed without residue. The bond strengths as well can be varied by additizing and/or by different comonomer compositions. In the inventive examples, 49 to 98 wt % of monomers A were used. Plasticizers as additives resulted in a low bond strength. On additization with a tackifying resin in example 6, as well, the reversibility was retainable. Comparative example 1, in contrast, exhibited residues of adhesive after removal when bonded to PC.

In order to examine the reversibility on very sensitive materials, inventive example 5 was used. According to Test method D, the bond strength to paper was measured and an examination was made to determine whether the material can be removed again without residue and without destruction. As a reference specimen, comparative example 1 was likewise bonded to paper, and the analogous test carried out. The results are set out in table 4.

TABLE 4

| | BS to paper | BS to paper | From the paper |
|---|---|---|---|
| | instantaneous | after 72 h | without |
| Example | [N/cm] | [N/cm] | destruction |
| 5 | 0.3 | 0.4 | Yes |
| Comparative | 4.6* | 5.2* | No |
| example 1 | | | |

*Maximum bond strength values measured.

The data listed in the table illustrate the possibility for inventive example 5 to be detached from the paper again very well without residue and without destruction. In contrast, comparative example 1, with a high acrylic acid content and a noninventive composition, adheres very strongly to paper and also leads to the tearing of the paper on detachment.

1. A pressure-sensitive adhesive comprising an at least partly crosslinked polyacrylate based on a monomer mixture, said monomer mixture comprising
a) 5 to 100 wt % of acrylic esters of the formula CR³₂═C(R²)(COOR¹) as monomers A, where R¹ is a branched alkyl group having 16 to 22 C atoms, and has at least two branching locations, R² is selected from the group consisting of H, methyl and halogen, and R³ independently at each occurrence is selected from the group consisting of H and halogen,
b) 0 to 95 wt % of acrylic esters of the formula CR⁶₂═C(R⁵)(COOR⁴) as monomers B, where R⁴ is a linear, singly branched, cyclic or polycyclic alkyl group having 1 to 14 C atoms, R⁵ is selected from the group consisting of H, methyl and halogen, and R⁶ independently at each occurrence is selected from the group consisting of H and halogen,
c) 0 to 5 wt % of monomers having at least one alcoholic hydroxyl group as monomers C,
d) 0 to 5 wt % of monomers having at least one COOH group as monomers D,
e) 0 to 5 wt % of monomers having at least one epoxy group as monomers E, and
f) 0 to 2.5 wt % of monomers having at least one UV-activatable group as monomers F.

2. The pressure-sensitive adhesive of claim 1, at least half of the monomers A having an alkyl group R¹ with three or more branching locations.

3. The pressure-sensitive adhesive of claim 1, wherein, R² is H or methyl and R³ is H in the monomers A.

4. The pressure-sensitive adhesive of claim 1, wherein the alkyl groups R¹ of the monomers A have a main chain on which side chains are attached at the branching locations, and at least 75% of the side chains have 2 to 4 C atoms.

5. The pressure-sensitive adhesive of claim 1, wherein R⁴ in the monomers B is selected from the group consisting of methyl, ethyl, propyl, pentyl, hexyl, heptyl, octyl, nonyl, decyl, undecyl, lauryl, and the branched isomers thereof, cycloalkyl groups and polycyclic alkyl groups, it being possible for the cycloalkyl groups and polycyclic alkyl groups to be substituted by alkyl groups, halogen atoms or cyano groups, and combinations thereof.

6. The pressure-sensitive adhesive of claim 1, wherein said monomer mixture comprises a fraction of at least 80 wt % of monomers A or of at least 80 wt % of the monomers A and B.

7. The pressure-sensitive adhesive of claim 1, wherein said monomer mixture comprises a fraction of monomers A of up to 40 wt %.

8. The pressure-sensitive adhesive of claim 1, wherein the monomer mixture comprises at least one of the monomers C, D, E, or F in a fraction of at least 0.01 wt %.

9. The pressure-sensitive adhesive of claim 1, wherein the pressure-sensitive adhesive comprises as additive plasticizers which are present with a fraction of up to 25 parts by weight, based on 100 parts by weight of polyacrylate, in the pressure-sensitive adhesive.

10. The pressure-sensitive adhesive of claim 1, wherein the pressure-sensitive adhesive comprises as additives tackifying resins which are present with a fraction of at least 0.01 and less than 20 parts by weight, based on 100 parts by weight of polyacrylate, in the pressure-sensitive adhesive.

11. The pressure-sensitive adhesive of claim 10, the tackifying resins having a DACP of less than −20° C.

12. A method for producing a pressure-sensitive adhesive of claim 1, comprising the following steps: (A) producing a monomer mixture, said monomer mixture comprising
a) 5 to 100 wt % of acrylic esters of the formula CR³₂═C(R²)(COOR¹) as monomers A, where R¹ is a branched alkyl group having from 16 to 22 C atoms, and has at least two branching locations, R² is selected from the group consisting of H, methyl and halogen, and R³ independently at each occurrence is H or halogen,
b) 0 to 95 wt % of acrylic esters of the formula CR⁶₂═C(R⁵)(COOR⁴) as monomers B, where R⁴ is a linear, singly branched, cyclic or polycyclic alkyl group having 1 to 14 C atoms, R⁵ is selected from the group consisting of H, methyl and halogen, and R⁶ independently at each occurrence is H or halogen,
c) 0 to 5 wt % of monomers having at least one alcoholic hydroxyl group as monomers C,
d) 0 to 5 wt % of monomers having at least one COOH group as monomers D,
e) 0 to 5 wt % of monomers having at least one epoxy group as monomers E, and
f) 0 to 2.5 wt % of monomers having at least one UV-activatable group as monomers F; (B) polymerizing the monomer mixture to form polyacrylate; (C) optionally admixing the polyacrylate with an additive and/or a crosslinker; and (D) at least partly crosslinking a mixture obtained by step (B) and the optional step (C), to form the pressure-sensitive adhesive.

13. The method of claim 12, step (B) being carried out in a solvent.

14. The method of claim 13, the solvent being removed by heating in a further step (E).

15. The method of claim 12, the crosslinking in step (D) taking place by irradiation with UV radiation, by irradiation with an ionizing radiation, thermally, or by a combination thereof.

16. An adhesive tape comprising a pressure-sensitive adhesive of claim 1 and a carrier, and the carrier being provided with the pressure-sensitive adhesive.

17. The method of claim 16, the carrier being provided with the pressure-sensitive adhesive by application to the carrier of the mixture obtained by step (B) and the optional step (C), and by subsequent crosslinking in step (D).

18. An adhesive tape which has a carrier and at least one adhesive layer that comprises a pressure-sensitive adhesive of claim 1.

19. A method for manufacturing or repairing electronic devices, wherein said electronic devices are manufactured or repaired with the pressure-sensitive adhesive of claim 1.

20. A method for producing a pressure-sensitive adhesive which is suitable for reversible bonding, which comprises producing said pressure-sensitive adhesive with acrylic esters of the formula CR³₂═C(R²)(COOR¹) where R¹ is a branched alkyl group having 16 to 22 C atoms, and has at least two branching locations, R² is selected from the croup consisting of H, methyl and halogen, and R³ independently at each occurrence is H or halogen.
